(19) United States
(12) Patent Application Publication
(10) Pub. No.: US 2015/0209952 A1
(43) Pub. Date: Jul. 30, 2015

(54) AUXILIARY HANDLE AND ELECTRIC POWER TOOL PROVIDED WITH THE AUXILIARY HANDLE

(71) Applicant: PANASONIC INTELLECTUAL PROPERTY MANAGEMENT CO., LTD., Osaka (JP)

(72) Inventors: Kazuhiko NISHII, Shiga (JP); Hidezumi OKAMURA, Mie (JP)

(73) Assignee: PANASONIC INTELLECTUAL PROPERTY MANAGEMENT CO., LTD., Osaka (JP)

(21) Appl. No.: 14/607,190

(22) Filed: Jan. 28, 2015

(30) Foreign Application Priority Data
Jan. 30, 2014 (JP) 2014-015628

(51) Int. Cl. B25F 5/02

(52) U.S. Cl. CPC B25F 5/026

(57) ABSTRACT

An auxiliary handle includes a base portion having a tubular shape, a connection portion accommodated within an internal space of the base portion in a state in which the connection portion is movable in an axial direction of the base portion, and a band portion curved along an outer circumferential surface of the body case. The band portion includes opposite end portions connected to each other through the connection portion within the internal space of the base portion. The auxiliary handle further includes an adjusting mechanism configured to, by moving the connection portion in the axial direction, change a position of the opposite end portions of the band portion and adjust a length of a part of the band portion exposed from the base portion. The base portion includes a rib for defining a limit of movement of the band portion toward the other axial end portion.

### CROSS-REFERENCE TO RELATED APPLICATION

This application claims priority to Japanese Patent Application No. 2014-015628 filed on Jan. 30, 2014, the entire contents of which are incorporated herein by reference.

### TECHNICAL FIELD

The present disclosure relates to an auxiliary handle and an electric power tool provided with the auxiliary handle. More particularly, the present disclosure pertains to a technology of preventing breakage and deformation of an auxiliary handle.

### BACKGROUND ART

In an electric power tool, such as a hammer or a hammer drill, which reciprocates a tool bit at a predetermined period, vibration is usually generated from a body of the electric power tool. If the vibration grows larger, it is sometimes the case that the posture of the electric power tool cannot be stably maintained by merely holding a handle extending from the body. Under these circumstances, it is usual to mount a removable auxiliary handle to the body of the electric power tool and to operate the electric power tool with both hands by holding the main handle with one hand and holding the auxiliary handle with the other hand.

As one example of the removable auxiliary handle, there is known a band-type auxiliary handle 900 shown in FIG. 12 (see Japanese Unexamined Patent Application Publication No. 2001-88059). The auxiliary handle 900 includes a strip-shaped band portion 910, a connection portion 920 to which the opposite ends 911 of the band portion 910 are fixed, a base portion 930 which accommodates the connection portion 920, and a grip portion 950 extending from the base portion 930. As shown in FIG. 13, the auxiliary handle 900 is mounted to an electric power tool 901 by wrapping the band portion 910 around the outer circumferential surface of a body case 903 of the electric power tool 901 and tightening the band portion 910 in that state.

The base portion 930 is often made of a resin rather than a metal in an effort to reduce the weight of the auxiliary handle 900. In order to make compatible the size reduction of the base portion 930 and the securing of the internal volume, it is desirable that the outer wall of the base portion 930 has a reduced thickness. Furthermore, if the thickness of the outer wall is not uniform, there is a possibility that a warp is generated in the outer wall and the base portion 930 is deformed. For that reason, it is preferred that the thickness of the outer wall is kept as uniform as possible. Considering this situation, it is not easy to sufficiently secure the mechanical strength of the base portion 930.

Under these circumstances, if the band portion 910 is excessively tightened with a view to avoiding removal of the auxiliary handle 900 from the electric power tool 901, there is a fear that the outer wall of the base portion 930 cannot endure the tightening force and may be damaged or deformed. The damage or deformation of the outer wall is particularly easy to occur in the portion which makes contact with the band portion 910 and easily receives a stress from the band portion 910, i.e., in the end portion 931 of the base portion 930 near the band portion 910. If damage or deformation occurs in the base portion 930, there is a risk that a problem is posed in securing the safety during a work. In addition, the design of the auxiliary handle 900 is impaired.

### SUMMARY OF THE INVENTION

In view of the above, the present disclosure provides an auxiliary handle which is hardly damaged or deformed by the tightening of a band portion, and an electric power tool provided with the auxiliary handle.

In accordance with an aspect of the present invention, there is provided an auxiliary handle for an electric power tool including: a base portion having a tubular shape, whose one axial end portion is to be brought into contact with a body case of the electric power tool; a connection portion accommodated within an internal space of the base portion in a state in which the connection portion is movable in an axial direction of the base portion; a band portion curved into an arc shape along an outer circumferential surface of the body case, the band portion including opposite end portions connected to each other through the connection portion within the internal space of the base portion; a grip portion attached to the other axial end portion of the base portion; and an adjusting mechanism configured to, by moving the connection portion in the axial direction, change a position of the opposite end portions of the band portion and adjust a length of a part of the band portion exposed from the base portion, wherein the base portion is provided with at least one rib for defining a limit of movement of the band portion toward the other axial end portion of the base portion.

The at least one rib may include a stopper surface capable of making contact with the band portion, the rib configured to define the limit of movement of the band portion toward the other axial end portion as the band portion makes contact with the stopper surface.

A region of the at least one rib where the stopper surface is formed may be made of a metal.

A region of the at least one rib where the stopper surface is formed may include an elastic body.

The at least one rib may be provided on an inner circumferential surface of the base portion.

The base portion may be made of a resin.

The at least one rib may include a plurality of ribs provided in the base portion.

An electric power tool provided with an auxiliary handle, including: an electric power tool; and the auxiliary handle described above mounted to a body case of the electric power tool.

In the auxiliary handle according to one aspect of the present invention, the base unit includes at least one rib which defines the limit of movement of the band portion toward the other end in the longitudinal direction. Accordingly, the stress transferred from the band portion to the band-portion-side end portion of the base portion is dispersed by the rib. Thus, the base portion is hardly damaged or deformed by the tightening of the band portion.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 is a perspective view showing an electric power tool provided with an auxiliary handle according to an embodiment of the present invention.

FIG. 2 is a perspective view showing the auxiliary handle according to the embodiment of the present invention.

FIG. 3 is a sectional view showing the auxiliary handle according to the embodiment of the present invention.

FIG. 4 is a sectional perspective view showing major parts of the auxiliary handle according to the embodiment of the present invention.

FIG. 5 is a front view showing a base portion according to the embodiment of the present invention.

FIG. 6 is a plan view showing the base portion according to the embodiment of the present invention.

FIG. 7 is a sectional side view taken along line VII-VII in FIG. 6.

FIG. 8 is a sectional view for explaining ribs according to a first modification.

FIG. 9 is a sectional perspective view for explaining ribs according to a second modification.

FIG. 10 is a sectional view for explaining ribs according to a third modification.

FIG. 11 is a plan view for explaining the ribs according to the third modification.

FIG. 12 is a partially cutaway front view showing a conventional auxiliary handle.

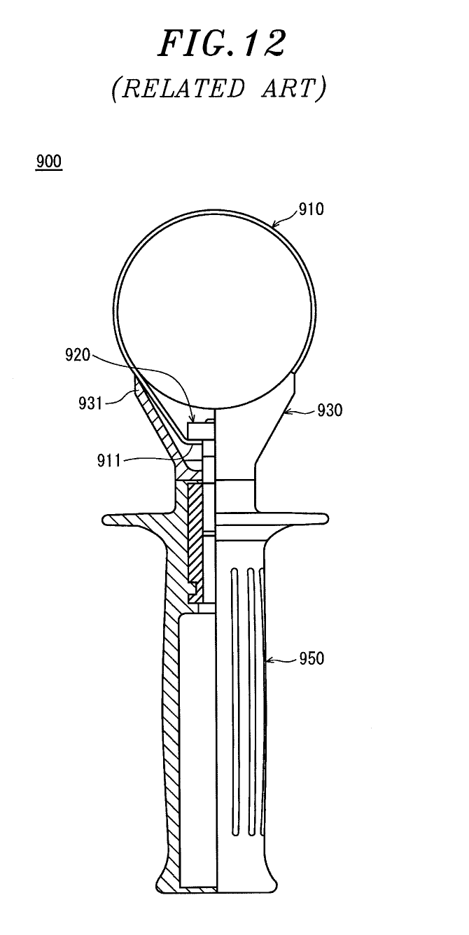

FIG. 13 is a plan view showing an electric power tool provided with the conventional auxiliary handle.

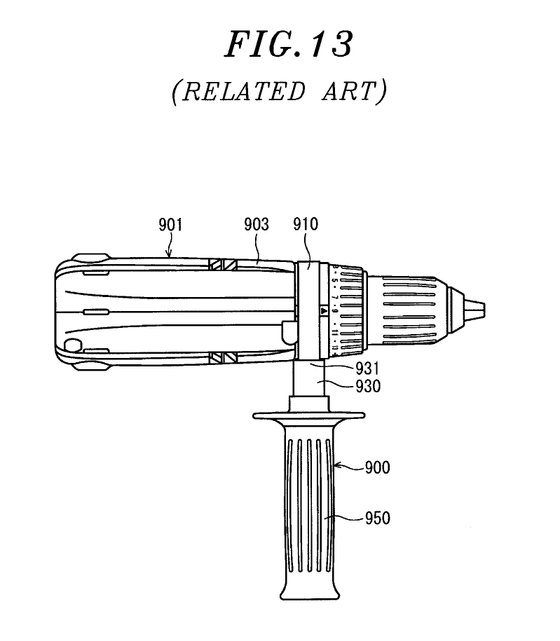

### DETAILED DESCRIPTION

An auxiliary handle according to an embodiment of the present invention and an electric power tool provided with the auxiliary handle will now be described with reference to the accompanying drawings which form a part hereof.

(Electric Power Tool)

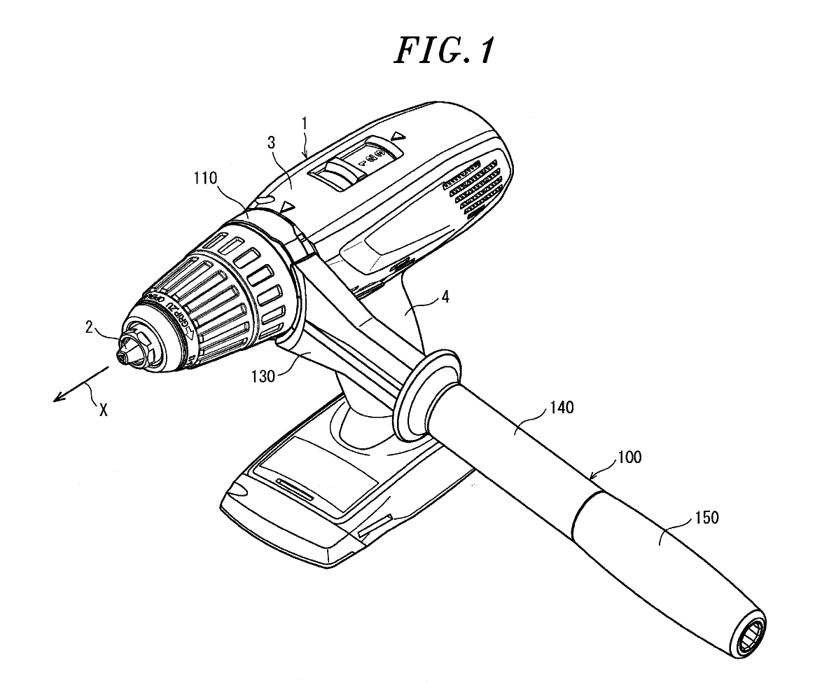

FIG. 1 is a perspective view showing an electric power tool provided with an auxiliary handle according to one embodiment of the present invention. As shown in FIG. 1, the electric power tool provided with an auxiliary handle according to one embodiment of the present invention includes an electric power tool 1 and an auxiliary handle 100 mounted to the electric power tool 1.

The electric power tool 1 is, e.g., a hammer that performs a hammer work with respect to a workpiece by causing a tool bit (not shown) held by a tool holder 2 to make a striking motion in the major axis direction of the tool bit (the direction indicated by an arrow X in FIG. 1). The electric power tool 1 includes a body case 3 which accommodates an electric motor, a motion converting mechanism and a striker (all of which are not shown). The auxiliary handle 100 is mounted to the body case 3. The rotary motion of the electric motor is converted to a reciprocating motion of a piston by the motion converting mechanism. A striking force generated by the reciprocating motion of the piston is transferred to the tool bit by the striker. By virtue of the striking force, the tool bit makes a striking motion in the X-axis direction at a predetermined period.

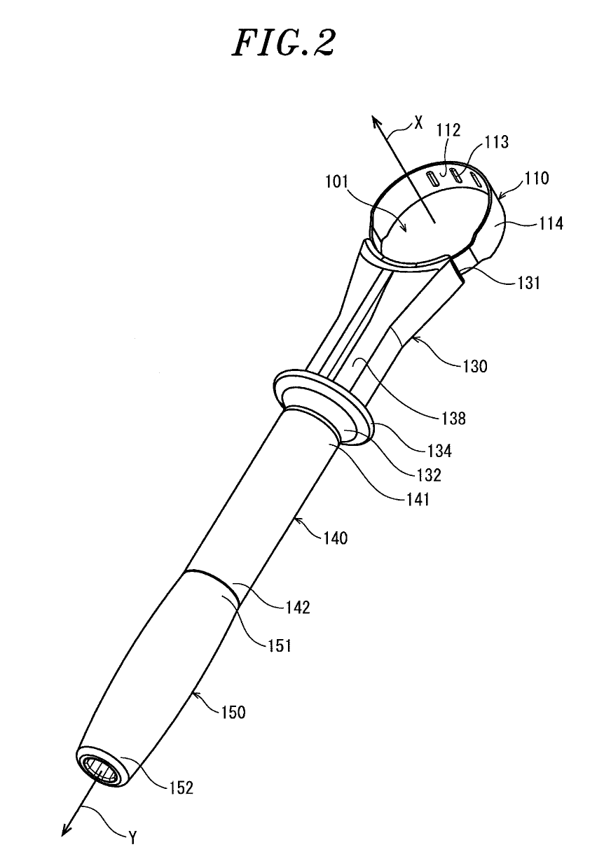

FIG. 2 is a perspective view showing the auxiliary handle according to the embodiment of the present invention. As shown in FIG. 2, the auxiliary handle 100 is a band-type auxiliary handle removably mounted to the body case 3 of the electric power tool 1. The auxiliary handle 100 is mounted such that, as shown in FIG. 1, the auxiliary handle 100 protrudes to the left side or the right side of the electric power tool 1. By mounting the auxiliary handle 100 to the electric power tool 1, a worker can operate the electric power tool 1 with both hands by holding a main handle 4 with one hand and holding the auxiliary handle 100 with the other hand.

(Auxiliary Handle)

(Schematic Configuration)

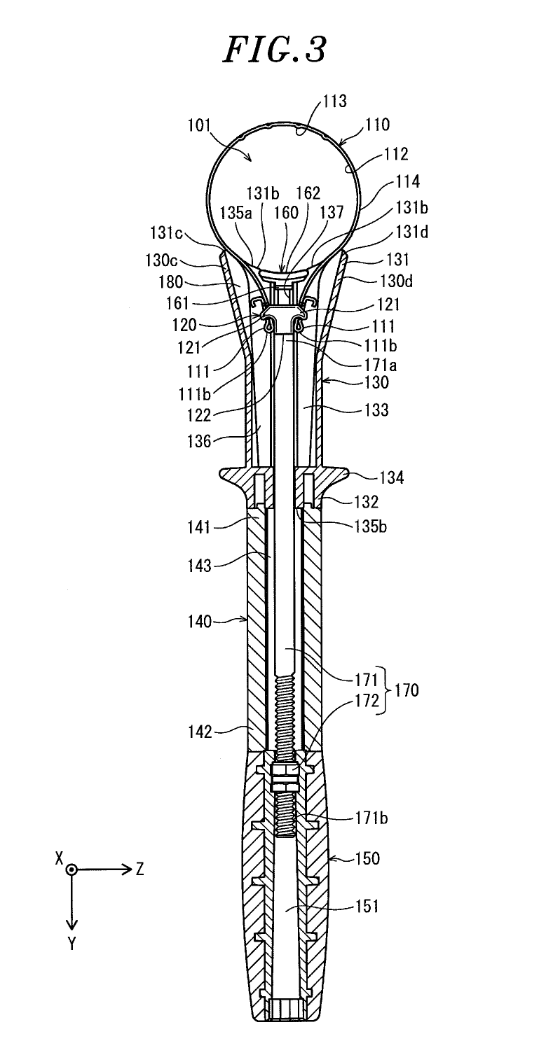

FIG. 3 is a sectional view showing the auxiliary handle according to the embodiment of the present invention. As shown in FIG. 3, the auxiliary handle 100 includes, e.g., a band portion 110, a connection portion 120, a base portion 130, a shaft portion 140, a grip portion 150, a cover portion 160, an adjusting mechanism 170 and ribs 180.

(Band Portion)

The band portion 110 is a long strip-shaped member which can be wrapped around the outer circumferential surface of the body case 3 of the electric power tool 1. The band portion 110 is curved into an arc shape substantially close to a circle along the outer circumferential surface of the body case 3. The opposite end portions 111 of the band portion 110 are interconnected through the connection portion 120 within an internal cylinder space 133. As shown in FIG. 2, a plurality of linear bulging portions 113 extending in a width direction of the band portion 110 is formed on an inner surface 112 of the band portion 110 in a spaced-apart relationship with each other. When the band portion 110 is wrapped around the body case 3, the bulging portions 113 come into engagement with recess portions (not shown) formed on the outer surface of the body case 3, thereby preventing the band portion 110 from rotating relative to the body case 3.

When the band portion 110 is mounted to the electric power tool 1, the width direction of the band portion 110 coincides with the major axis direction (X-axis direction) of the tool bit. For the sake of convenience in description, the width direction of the band portion 110 of the auxiliary handle 100 will be referred to as an X-axis direction. The longitudinal direction of the base portion 130 of the auxiliary handle 100 will be referred to as a Y-axis direction. The direction orthogonal to both the X-axis direction and the Y-axis direction will be referred to as a Z-axis direction. In the Y-axis direction, the side of the band portion 110 will be referred to as “one end side” or “upper side” and the side of the grip portion 150 will be referred to as “the other end side” or “lower side”.

(Connection Portion)

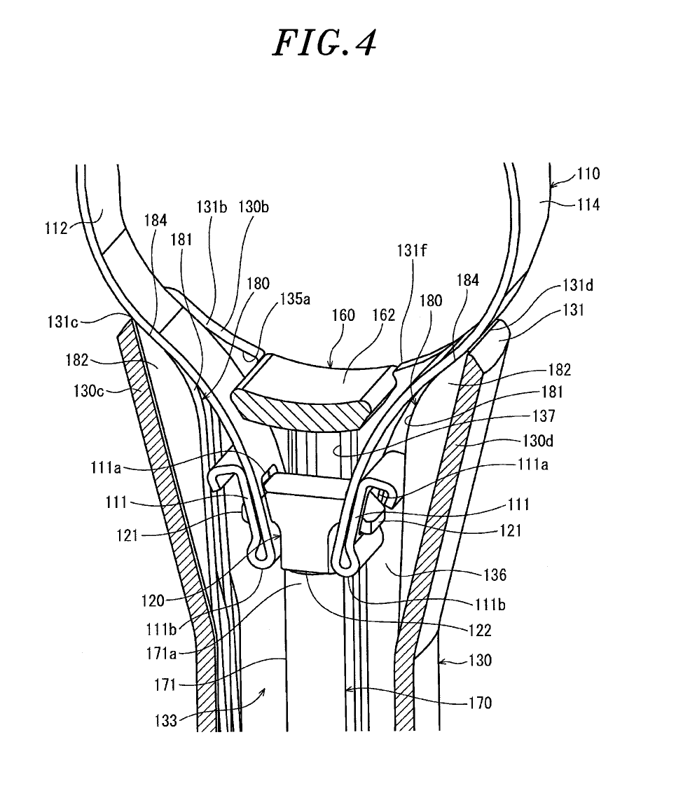

FIG. 4 is a sectional perspective view showing major parts of the auxiliary handle according to the embodiment of the present invention. As shown in FIG. 4, the connection portion 120 has a substantially T-like shape when seen in the X-axis direction (see FIG. 3) and includes a pair of engaging portions 121 protruding toward the opposite sides in the Z-axis direction. The opposite end portions 111 of the band portion 110 are fixed to the engaging portions 121. More specifically, through-holes 111a are formed in each of the opposite end portions 111 of the band portion 110. Using the through-holes 111a, the opposite end portions 111 are hooked on the engaging portions 121.

The opposite end portions 111 of the band portion 110 and the connection portion 120 are accommodated within the internal space 133 of the base portion 130 so that they can move in the Y-axis direction. The Y-axis direction positions of the opposite end portions 111 of the band portion 110 and the connection portion 120 can be arbitrarily adjusted by the adjusting mechanism 170 attached to the connection portion 120.

(Base Portion)

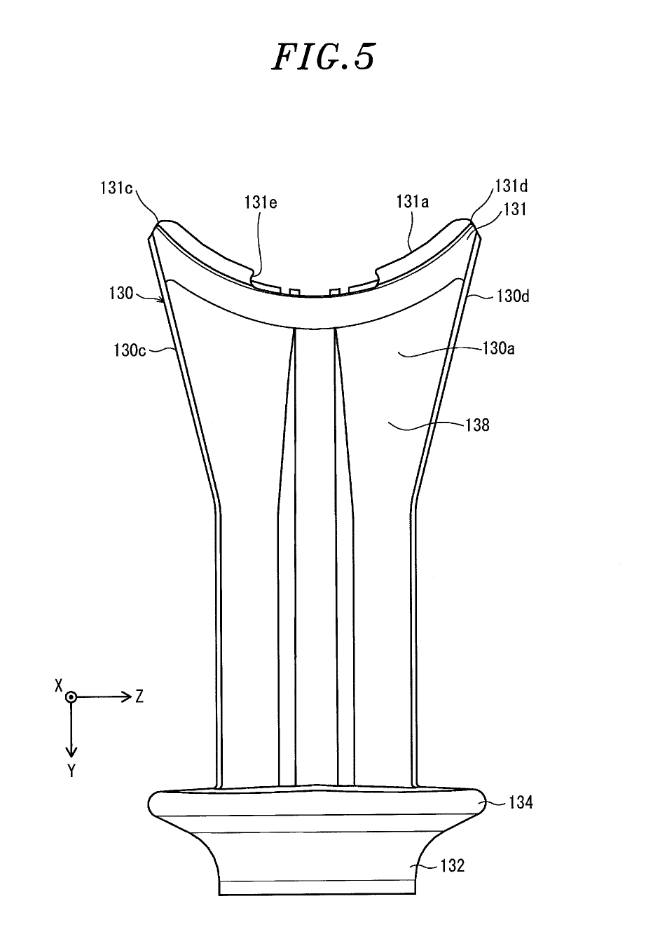

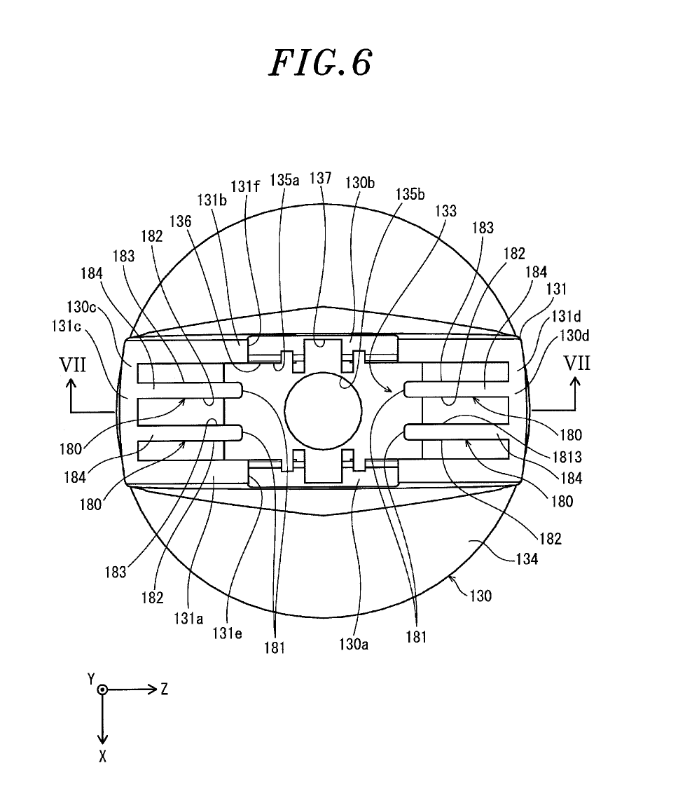

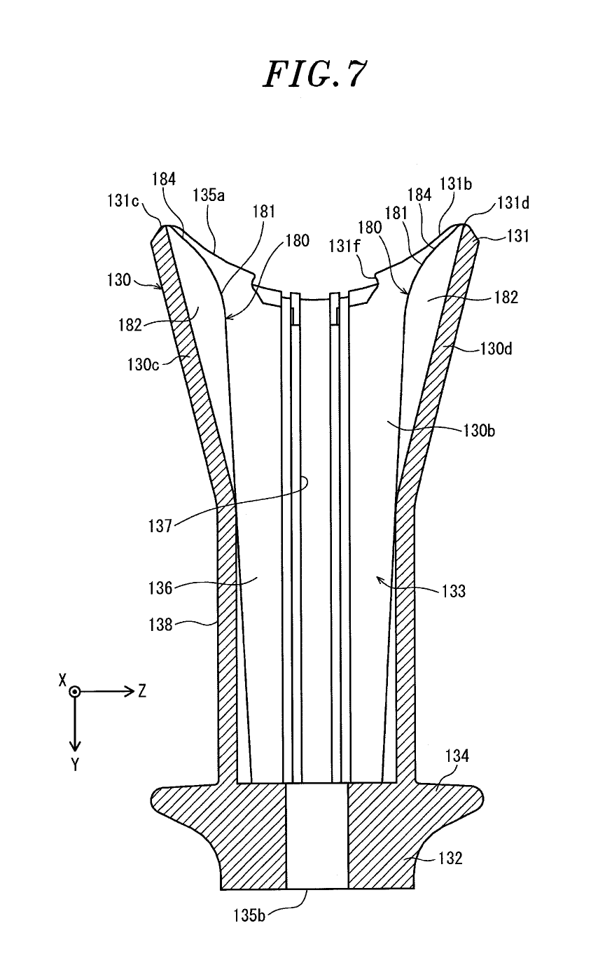

FIG. 5 is a front view showing the base portion according to one embodiment of the present invention. FIG. 6 is a plan view showing the base portion according to one embodiment of the present invention. FIG. 7 is a sectional side view taken along line VII-VII in FIG. 6. As shown in FIGS. 5 to 7, the base portion 130 is, e.g., a cylindrical member having openings 135a and 135b (see FIG. 7) formed at the Y-axis direction opposite sides thereof. The base portion 130 is made of a resin. The opposite end portions 111 of the band portion 110 and the connection portion 120 are accommodated within one Y-axis-direction end portion 131 of the base portion 130. A flange portion 134 is provided near the other Y-axis-direction end portion 132 of the base portion 130.

The upper portion (one Y-axis-direction end portion) of the base portion 130 existing more upward than the flange portion 134 is formed into a rectangular tube shape and is composed of four outer walls 130a to 130d (see FIG. 6). The respective outer walls 130a to 130d have a substantially uniform thickness such that a warp is not generated in the respective outer walls 130a to 130d. The outer walls 130a and 130b opposite to each other in the X-axis direction have a Z-axis-direction width which becomes gradually larger toward one Y-axis-direction end. Thus, the distance between the outer walls 130c and 130d becomes gradually larger toward one Y-axis-direction end. Since the band portion 110 is partially accommodated within one Y-axis-direction end portion of the base portion 130, the internal cylinder space 133 of the base portion 130 is enlarged in conformity with the shape of the band portion 110. The distance between the outer walls 130a and 130b is uniform in the X-axis direction and the Y-axis direction and is a little larger than the width of the band portion 110.

The edges 131a and 131b of the outer walls 130a and 130b existing at one Y-axis-direction end side are curved into a substantially arc-like shape in conformity with the shape of the outer surface of the body case 3 and are designed so as to fit to the body case 3 as contact surfaces which make contact with the outer surface of the body case 3. The edges 131c and 131d of the outer walls 130c and 130d existing at one Y-axis-direction end side are surfaces which make contact with the outer surface 114 of the band portion 110. The edges 131c and 131d are not curved.

Referring back to FIG. 3, when the auxiliary handle 100 is seen in the X-axis direction, the opposite end portions 111 of the band portion 110 are accommodated within the internal cylinder space 133 of the base portion 130. Therefore, the portions of the band portion 110 exposed from the base portion 130 has an arc shape. A circular through-hole 101 is defined by the exposed portion of the band portion 110 and one Y-axis-direction end portion 131 of the base portion 130. The body case 3 of the electric power tool 1 is inserted into the through-hole 101. If the diameter of the through-hole 101 is reduced with the body case 3 inserted into the through-hole 101, it is possible to compress the body case 3 interposed between the edges 131a and 131b of the base portion 130 and the band portion 110. By virtue of this tightening operation, the base portion 130 is stably fixed to the body case 3.

(Shaft Portion)

The shaft portion 140 has, e.g., an elongated cylinder shape and includes one Y-axis-direction end portion 141 connected to the base portion 130 and the other Y-axis-direction end portion 142 connected to the grip portion 150. That is to say, the grip portion 150 is attached to the base portion 130 through the shaft portion 140. By interposing the shaft portion 140, it is possible to prolong the distance from the base portion 130 to the grip portion 150 and to secure such a length that a worker is not shaken by the inertial torque of the electric power tool 1.

The internal cylinder space 143 of the shaft portion 140 communicates with the internal cylinder space 133 of the base portion 130 and also with the internal cylinder space 153 of the grip portion 150.

(Grip Portion)

The grip portion 150 has, e.g., an elongated cylinder shape. The grip portion 150 has such a thickness and a length that a worker can easily grip the grip portion 150. One Y-axis-direction end portion 151 of the grip portion 150 is connected to the shaft portion 140. The other Y-axis-direction end portion 152 of the grip portion 150 is a free end.

(Cover Portion)

The cover portion 160 is a member for preventing dust from entering the internal cylinder space 133 of the base portion 130 through the opening 135a of the base portion 130 existing at one Y-axis-direction end side. The cover portion 160 is disposed so as to close the opening 135a. The cover portion 160 includes a boss portion 161. By press-fitting the boss portion 161 into a fitting groove 137 formed on the inner surface of the base portion 130 (the inner surfaces of the outer walls 130a and 130b), the cover portion 160 is fixed to one Y-axis-direction end portion 131 of the base portion 130.

As shown in FIG. 4, recess portions 131e and 131f conforming to the shape of the cover portion 160 are formed in the edges 131a and 131b (only the edge 131b of which is shown in FIG. 4) of the base portion 130 existing at one Y-axis-direction end side. If the cover portion 160 is fitted into the recess portions 131e and 131f, the edges 131a and 131b become flush with the outer surface 162 of the cover portion 160, thereby forming an arc-shaped surface which extends along the outer surface of the body case 3 of the electric power tool 1.

(Adjusting Mechanism)

Referring back to FIG. 3, the adjusting mechanism 170 is a mechanism for moving the connection portion 120 in the Y-axis direction and is composed of, e.g., a threaded rod 171 and a nut 172. By moving the connection portion 120 in the Y-axis direction, the adjusting mechanism 170 changes the Y-axis-direction position of the opposite end portions 111 of the band portion 110. This makes it possible to adjust the length of the portion of the band portion 110 exposed from the base portion 130.

The threaded rod 171 extends in the Y-axis direction through the internal cylinder space 133 of the base portion 130, the internal cylinder space 143 of the shaft portion 140 and the internal cylinder space 153 of the grip portion 150 in a loosely-fitted state. One end portion 171a of the threaded rod 171 is rotatably connected to the connection portion 120 within the internal cylinder space 133 of the base portion 130. A thread is formed in the other end portion 171b of the threaded rod 171. The other end portion 171b of the threaded rod 171 threadedly engages with the nut 172.

The nut 172 is fixed to one Y-axis-direction end portion 151 of the internal cylinder space 153 of the grip portion 150. If the grip portion 150 is rotated, the nut 172 also rotates. By rotating the grip portion 150 and eventually rotating the nut 172, it is possible to tighten or loosen the band portion 110 with respect to the body case 3. In case of tightening the band portion 110, the grip portion 150 is rotated in a screw-tightening direction. If the grip portion 150 is rotated in the screw-tightening direction, the threaded rod 171 is linearly moved toward the other Y-axis-direction end side (the lower side) with respect to the nut 172 fixed to the grip portion 150. As a result, the connection portion 120 is moved toward the nut 172. The band portion 110 is pulled into the internal cylinder space 133 of the base portion 130. Consequently, the length of the portion of the band portion 110 exposed from the base portion 130 is reduced. The diameter of the through-hole 101 defined by the band portion 110 and the base portion 130 is reduced. Thus, the body case 3 can be compressed from the outside by the band portion 110 and the base portion 130. In this way, the base portion 130 is fixed to the outer circumferential surface of the body case 3, whereby the auxiliary handle 100 is stably mounted to the electric power tool 1.

In case of loosening the band portion 110, the grip portion 150 is rotated in a screw-loosening direction. If the grip portion 150 is rotated in the screw-loosening direction, the threaded rod 171 is linearly moved toward one Y-axis-direction end side (the upper side). As a result, the connection portion 120 is moved away from the nut 172.

The band portion 110 is gradually pushed out from the internal cylinder space 133 of the base portion 130. Consequently, the length of the portion of the band portion 110 exposed from the base portion 130 is increased. The diameter of the through-hole 101 is increased. Thus, the compression of the body case 3 by the band portion 110 and the base portion 130 becomes loose. When the band portion 110 is in a loosened and untightened state, the auxiliary handle 100 can be attached to or removed from the body case 3.

(Rib)

As shown in FIGS. 6 and 7, a plurality of flat ribs 180 for limiting the movement of the band portion 110 toward the other Y-axis-direction end side is provided on the inner circumferential surface 136 of the base portion 130. More specifically, the ribs 180 are formed in the region of the internal space 133 of the base portion 130 where the connection portion 120 and the band portion 110 are accommodated. The respective ribs 180 are formed on the inner surfaces of the outer walls 130c and 130d of the base portion 130, two on each inner surface, so as to extend along the Y-axis direction.

All the ribs 180 are identical in shape. Each of the ribs 180 includes an apex surface 181 and a pair of side surfaces 182 and 183. The side surfaces 182 and 183 are parallel to the Y-axis and the Z-axis. The side surfaces 182 and 183 are opposite to each other in the X-axis direction. The respective side surfaces 182 and 183 continuously extend from the inner surfaces of the outer walls 130c and 130d. The apex surface 181 is parallel to the X-axis. The apex surface 181 faces the inner surfaces of the outer walls 130c and 130d and continuously extends from the side surfaces 182 and 183. The ribs 180 are made of a resin and are one-piece formed with the base portion 130.

Gaps are provided between the respective ribs 180 and the outer walls 130a and 130b. A gap is provided between the ribs 180 adjoining each other. These gaps are narrower than the width-direction dimension of the band portion 110, thereby preventing the band portion 110 from entering the gaps. In each of the ribs 180, the region of the apex surface 181 existing at one Y-axis-direction end side becomes a stopper surface 184 with which the band portion 110 makes contact. The stopper surface 184 is shaped so as to extend along the outer surface 114 of the band portion 110.

The position of the stopper surface 184 coincides with the position of the outer surface 114 of the band portion 110 when the band portion 110 is tightened with a proper strength. Accordingly, if the tightening of the band portion 110 is insufficient, the outer surface 114 of the band portion 110 does not make contact with the stopper surface 184 of each of the ribs 180. On the other hand, if the band portion 110 is tightened with an excessive strength, the outer surface 114 of the band portion 110 is pressed against the stopper surface 184 of each of the ribs 180. Since the outer surface 114 of the band portion 110 makes contact with the stopper surface 184 of each of the ribs 180 in this way, it is possible to define the limit of movement of the band portion 110 toward the other Y-axis-direction end side.

In a hypothetical case where the base portion 130 is not provided with the ribs 180, if the band portion 110 is tightened with an excessive strength, the outer surface 114 of the band portion 110 makes contact with only the edges 131c and 131d of the outer walls 130c and 130d of the base portion 130. For that reason, stresses generated from the band portion 110 are concentrated on only the edges 131c and 131d with which the band portion 110 makes contact. Consequently, the outer walls 130c and 130d may possibly be damaged or deformed.

However, in case where the base portion 130 is provided with the ribs 180, even if the band portion 110 is tightened with an excessive strength, the band portion 110 does not make contact with the outer walls 130a to 130d of the base portion 130. That is to say, the band portion 110 first makes contact with the stopper surface 184 of each of the ribs 180. In that case, the band portion 110 makes contact, over a wide area, with the stopper surface 184 of each of the ribs 180 formed in conformity with the shape of the band portion 110. Thus, stresses are hardly concentrated and the ribs 180 are hardly damaged or deformed. In the auxiliary handle 100, stresses are dispersed by providing a plurality of ribs 180. Thus, the stresses borne by the respective ribs 180 become small. As a result, the respective ribs 180 are hardly damaged or deformed. In the present invention, the number of the ribs may be set arbitrarily. It may be possible to use, e.g., one rib.

Even if the band portion 110 is excessively tightened and the ribs 180 are damaged or deformed, stresses are reduced due to the damage or deformation of the ribs 180. Accordingly, there is no possibility that the outer walls 130a to 130d of the base portion 130 are damaged or deformed.

The ribs 180 are provided within the internal cylinder space 133 of the base portion 130. Therefore, even when the ribs 180 are damaged or deformed, the damage or deformation of the ribs 180 does not affect the outward appearance of the auxiliary handle 100 nor impair the design of the auxiliary handle 100. In the present invention, the ribs 180 may be provided at a location other than the internal cylinder space 133 of the base portion 130.

(Modifications)

The ribs of the auxiliary handle according to the present invention are not limited to the ribs 180 according to one embodiment described above. For example, the following modifications may be taken into account.

(First Modification)

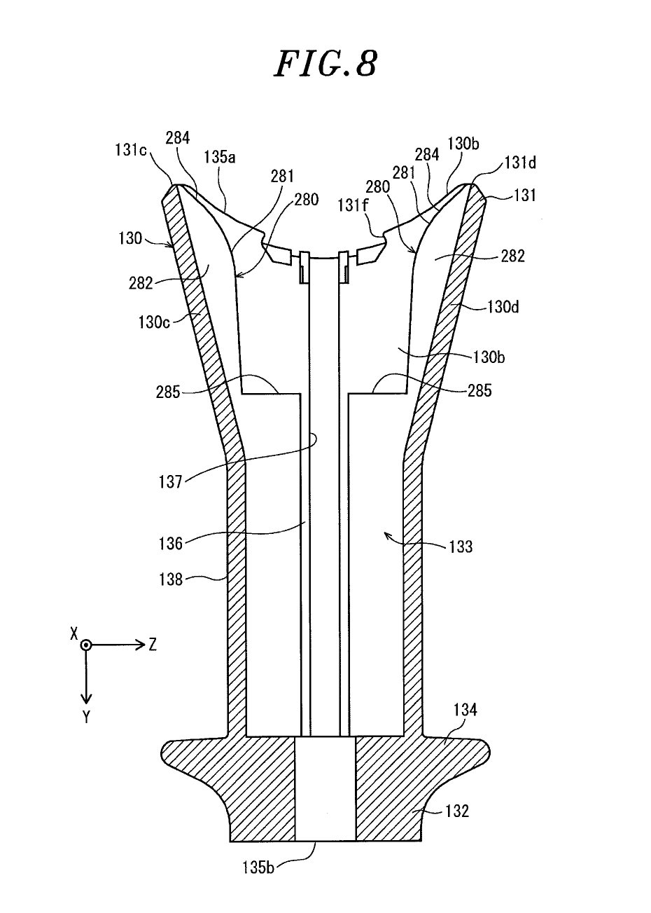

FIG. 8 is a sectional view for explaining ribs according to a first modification. As shown in FIG. 8, each of the ribs 280 according to the first modification includes not only a stopper surface 284 with which the arc-shaped curved portion of the band portion 110 makes contact, but also a stopper surface 285 with which each of the opposite end portions 111 of the band portion 110 makes contact.

Each of the ribs 280 includes an apex surface 281 and a pair of side surfaces 282. The side surfaces 282 are parallel to the Y-axis and the Z-axis. The side surfaces 282 opposite to each other in the X-axis direction. The respective side surfaces 282 continuously extend from the inner surfaces of the outer walls 130c and 130d. The apex surface 281 is parallel to the X-axis. The apex surface 281 faces the inner surfaces of the outer walls 130c and 130d and continuously extends from the side surfaces 282. The ribs 280 are made of a resin and are one-piece formed with the base portion 130. The stopper surface 284 of each of the ribs 280 is identical with the stopper surface 184 of each of the ribs 180 and therefore will not be described.

Each of the ribs 280 slightly overhangs toward the other Y-axis-direction end side (the lower side) beyond the position where the connection portion 120 is disposed. The surface of the overhanging portion existing at one Y-axis-direction end side becomes the stopper surface 285. The stopper surface 285 is parallel to the X axis and the Z axis. As shown in FIG. 4, the through-holes 111a are formed in each of the opposite end portions 111 of the band portion 110. As each of the opposite end portions 111 is folded back, the through-holes 111a come into an overlapping state. Then, each of the engaging portions 121 of the connection portion 120 is inserted into the overlapping through-holes 111a, whereby each of the opposite end portions 111 of the band portion 110 is fixed to the connection portion 120. The other Y-axis-direction end surfaces 111b of the band portion 110 are the curved corner regions of the opposite end portions 111 of the band portion 110. Each of the other Y-axis-direction end surfaces 111b makes contact with the stopper surface 285.

The position of the stopper surface 285 coincides with the position of the other Y-axis-direction end surfaces 111b of the band portion 110 when the band portion 110 is tightened with a proper strength. Accordingly, if the tightening of the band portion 110 is insufficient, each of the other Y-axis-direction end surfaces 111b of the band portion 110 does not make contact with the stopper surface 285 of each of the ribs 280. On the other hand, if the band portion 110 is tightened with an excessive strength, each of the other Y-axis-direction end surfaces 111b of the band portion 110 is pressed against the stopper surface 285 of each of the ribs 280. Since each of the other Y-axis-direction end surfaces 111b of the band portion 110 makes contact with the stopper surface 285 of each of the ribs 280 in this way, it is possible to define the limit of movement of the band portion 110 toward the other Y-axis-direction end side.

With the configuration of the first modification, the band portion 110 can make contact with both the stopper surface 284 and the stopper surface 285. This makes it possible to reliably define the limit of movement of the band portion 110. Alternatively, each of the ribs 280 may not be provided with the stopper surface 284 but may be provided with only the stopper surface 285, thereby defining the limit of movement of the band portion 110.

(Second Modification)

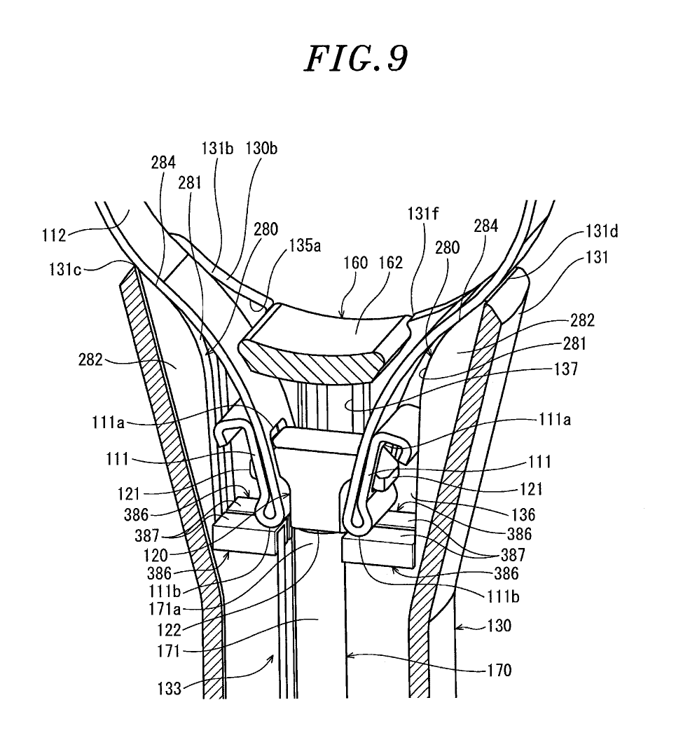

FIG. 9 is a sectional perspective view for explaining ribs according to a second modification. As shown in FIG. 9, in the ribs according to the second modification, the region of each of the ribs where a stopper surface 387 is formed is made of a metal.

More specifically, each of the ribs according to the second modification is composed of each of the ribs 280 according to the first modification and a reinforcing member 386. The reinforcing member 386 is formed by bending a flat metal plate into a substantially C-like shape. The reinforcing member 386 is externally fitted to the overhanging region of each of the ribs 280 where the stopper surface 285 is formed. One Y-axis-direction end surface (the upper surface) of the reinforcing member 386 becomes a stopper surface 387. If the region of each of the ribs where the stopper surface 387 is formed is made of a metal in this way, the mechanical strength of the stopper surface 387 is increased. Thus, the durability of the stopper surface 387 against the repeated tightening of the band portion 110 is improved.

The material of the reinforcing member 386 is not limited to a metal. The reinforcing member 386 may be composed of, e.g., an elastic body made of a material such as a rubber or the like. If the region of each of the ribs where the stopper surface 387 is formed is composed of an elastic body, the degradation of the stopper surface 387 is prevented. Thus, the durability of the stopper surface 387 against the repeated tightening of the band portion 110 is improved.

(Third Modification)

In the auxiliary handle 100 according to one embodiment of the present invention, the flat ribs 180 are disposed in an orientation orthogonal to the X axis. However, the orientation of the ribs according to the present invention is not limited thereto but may be set arbitrarily.

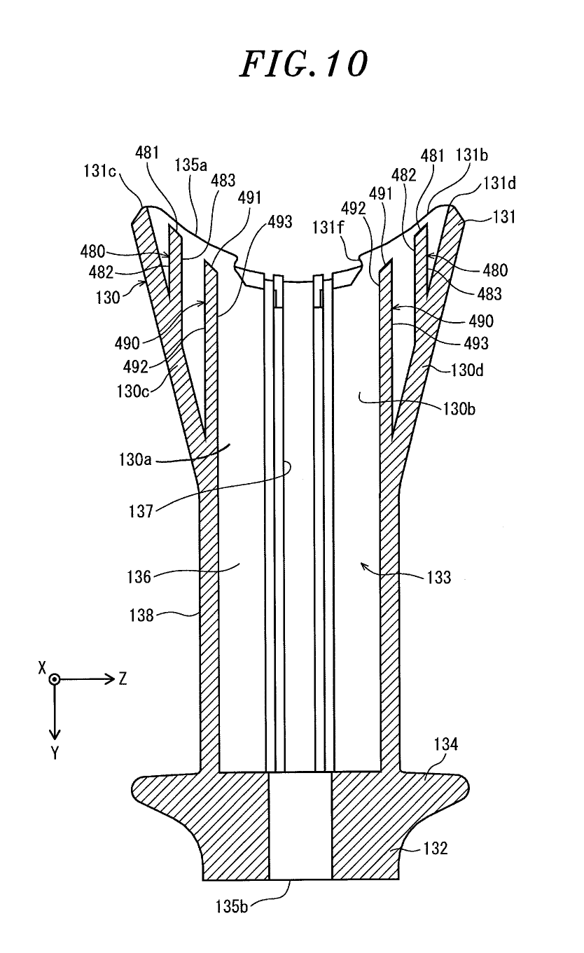

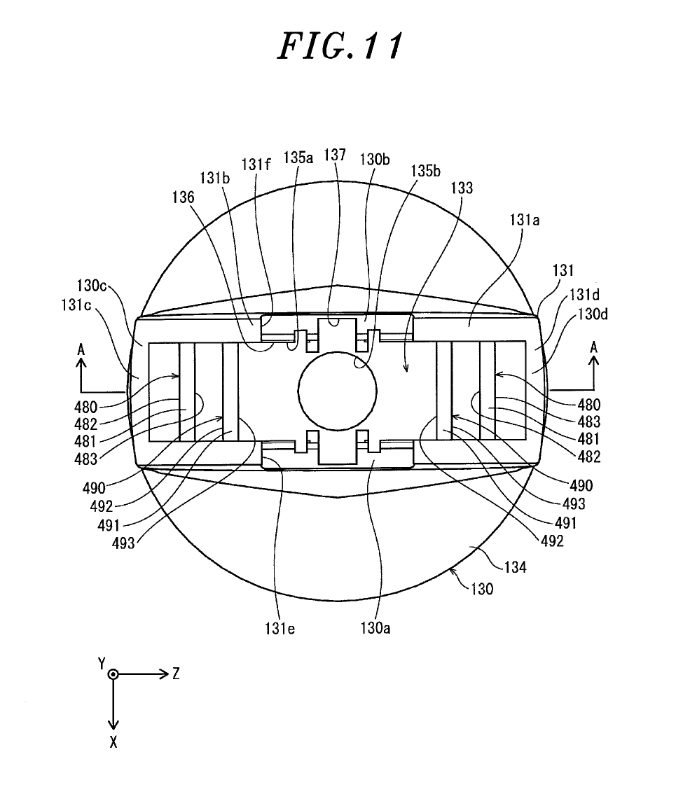

FIG. 10 is a sectional view for explaining ribs according to a third modification. FIG. 11 is a plan view for explaining the ribs according to the third modification. For example, as shown in FIGS. 10 and 11, the ribs 480 and 490 may be disposed in an orientation orthogonal to the Z axis. Each of the ribs 480 and 490 includes an apex surface 481 or 491 and a pair of side surfaces 482 and 483 or 492 and 493. The side surfaces 482 and 483 or 492 and 493 are parallel to the X axis and the Y axis. The side surfaces 482 and 483 or 492 and 493 face each other in the Z-axis direction and continuously extend from the inner circumferential surface 136. The apex surface 481 or 491 is formed so as to conform to the shape of the outer surface 114 of the band portion 110. The apex surface 481 or 491 continuously extends from the side surfaces 482 and 483 or 492 and 493. The ribs 480 and 490 are made of a resin and are one-piece formed with the base portion 130.

In each of the ribs 480 and 490, the entirety of the apex surface 481 or 491 is a stopper surface with which the band portion 110 makes contact. The position of the apex surface 481 or 491 coincides with the position of the outer surface 114 of the band portion 110 when the band portion 110 is tightened with a proper strength. Accordingly, if the tightening of the band portion 110 is insufficient, the outer surface 114 of the band portion 110 does not make contact with the apex surface 481 of the rib 480 or the apex surface 491 of the rib 490. On the other hand, if the band portion 110 is tightened with an excessive strength, the outer surface 114 of the band portion 110 is pressed against the apex surface 481 of the rib 480 or the apex surface 491 of the rib 490. Since the outer surface 114 of the band portion 110 makes contact with the apex surface 481 of the rib 480 or the apex surface 491 of the rib 490 in this way, it is possible to define the limit of movement of the band portion 110 toward the other Y-axis-direction end side.

With the configuration according to the third modification, the respective ribs 480 and 490 are connected to three of the outer walls 130a to 130d. For that reason, the respective ribs 480 and 490 have high mechanical strength. Thus, the ribs 480 and 490 are hardly damaged or deformed by the stresses generated due to the tightening operation.

(Other Modifications)

While the configuration of the present invention has been described above based on the embodiment and modifications, the present invention is not limited to the embodiment and modifications described above. For example, the partial configurations of the embodiment and modifications described above may be appropriately combined with one another. In addition, the configuration of the present invention may be appropriately modified without departing from the scope of the technical concept of the present invention.

The present invention can be extensively used in a variety of electric power tools. Thus, the present invention is not limited to the hammer that performs a hammer work with respect to a workpiece by causing a tool bit to make a striking motion in a major-axis direction. For example, the present invention may be applied to a hammer drill that performs a hammer drill work with respect to a workpiece by causing a tool bit to make a striking motion and a rotating motion. Moreover, the present invention may be applied to not only a striking tool such as a hammer or a hammer drill but also to a cutting tool such as a reciprocating saw or a jigsaw that performs a cutting work with respect to a workpiece by causing a blade to make a reciprocating linear motion.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. An auxiliary handle for an electric power tool comprising:
a base portion having a tubular shape, whose one axial end portion is to be brought into contact with a body case of the electric power tool;
a connection portion accommodated within an internal space of the base portion in a state in which the connection portion is movable in an axial direction of the base portion;
a band portion curved into an arc shape along an outer circumferential surface of the body case, the band portion including opposite end portions connected to each other through the connection portion within the internal space of the base portion;
a grip portion attached to the other axial end portion of the base portion; and
an adjusting mechanism configured to, by moving the connection portion in the axial direction, change a position of the opposite end portions of the band portion and adjust a length of a part of the band portion exposed from the base portion, wherein the base portion is provided with at least one
rib for defining a limit of movement of the band portion toward the other axial end portion of the base portion.

2. The handle of claim 1, wherein the at least one rib includes a stopper surface capable of making contact with the band portion, the at least one rib being configured to define the limit of movement of the band portion toward the other axial end portion as the band portion makes contact with the stopper surface.

3. The handle of claim 2, wherein a region of the at least one rib where the stopper surface is formed is made of a metal.

4. The handle of claim 2, wherein a region of the at least one rib where the stopper surface is formed includes an elastic body.

5. The handle of claim 1, wherein the at least one rib is provided on an inner circumferential surface of the base portion.

6. The handle of claim 1, wherein the base portion is made of a resin.

7. The handle of claim 1, wherein the at least one rib includes a plurality of ribs provided in the base portion.

8. An electric power tool provided with an auxiliary handle, comprising:
an electric power tool; and
an auxiliary handle mounted to a body case of the electric power tool, the auxiliary handle including: a base portion having a tubular shape, whose one axial end portion is to be brought into contact with the body case of the electric power tool; a connection portion accommodated within an internal space of the base portion in a state in which the connection portion is movable in an axial direction of the base portion; a band portion curved into an arc shape along an outer circumferential surface of the body case, the band portion including opposite end portions connected to each other through the connection portion within the internal space of the base portion; a grip portion attached to the other axial end portion of the base portion; and an adjusting mechanism configured to, by moving the connection portion in the axial direction, change a position of the opposite end portions of the band portion and adjust a length of a part of the band portion exposed from the base portion, wherein the base portion is provided with at least one rib for defining a limit of movement of the band portion toward the other axial end portion of the base portion.
